(19) United States
(12) Patent Application Publication
(10) Pub. No.: US 2025/0079545 A1
(43) Pub. Date: Mar. 6, 2025

(54) Separation method for recycling a spent battery electrode

(71) Applicants: Xueyuan Nie, Windsor (CA); Jingzeng Zhang, Windsor (CA)

(72) Inventors: Xueyuan Nie, Windsor (CA); Jingzeng Zhang, Windsor (CA)

(21) Appl. No.: 18/457,128

(22) Filed: Aug. 28, 2023

(51) Int. Cl. H01M 10/54; B03C 11/00; H01M 4/38

(52) U.S. Cl. CPC H01M 10/54; B03C 11/00; H01M 4/382; H01M 10/0525; H01M 2300/0002

(57) ABSTRACT

This invention involves a separation method of a spent battery material. The spent battery electrode is first obtained by disassembling an electrical battery manually or preferably through robot automation. A voltage of less than 600 V is applied onto a surface of the spent electrode where localized gas bubbles form and collapse directly on the electrode surface. The gas bubble collapsing generates the impacting force on the electrode material surface and causes a separation of the battery material. As a result, the battery electrode (active) material is removed from Al or Cu current collector. The electrode active material can be subsequently recycled or regenerated. The Al and Cu collectors can be straightly re-used.

### TECHNICAL FIELD

This invention involves a separation method of a spent battery electrode material for battery materials recycling and regeneration which is needed for circular economy of battery electric vehicles and energy storage applications.

### BACKGROUND OF THE INVENTION

The use of batteries including lithium-ion batteries (LIBs) has increased exponentially. However, their manufacturing and disposal have increasingly become subjects of political and environmental concerns. World reserves of lithium, cobalt, and other metals are limited and unevenly distributed, while their mining is energy and labor intensive and creates considerable pollution. The significant LIB waste is and will be generated each year, which, if not recycled and reused, will exert massive environmental impacts and accelerate the depletion of mineral reserves. Adding to the recycling difficulty, LIBs are complicated structures comprising one of five common cathodes, an anode, electrolyte, a separator, and current collectors along with packaging components.

Due to the complex structure and number of materials in LIBs, they must be subjected to a variety of processes prior to reuse or recycling. LIBs must be first classified and most often pretreated through discharge or inactivation, disassembly, and separation after which they can be subjected to direct recycling, pyrometallurgy, hydrometallurgy, or a combination of methods.

Pyrometallurgical methods require simpler pretreatment methods (most often shredding or crushing) to prepare batteries for recycling. Pyrometallurgy uses heating to convert metal oxides used in battery materials to metals or metal compounds. However, the mechanically shredding or crushing of the battery also destroy the current collectors, and the Al collectors without separation from the battery active material would contaminate the precious metals, cobalt, nickel, manganese and copper. The slag contains lithium and aluminum.

Hydrometallurgical methods use primarily aqueous solutions to extract and separate metals from LIBs. The pretreated battery materials are most often extracted with H₂SO₄ and H₂O₂, although HCl, HNO₃, and organic acids including citric and oxalic acids are commonly used. Once metals have been extracted into solution, they are precipitated selectively as salts using pH variation or extracted using organic solvents. However, to be efficient, the Al and Cu current collectors have to be previously removed. There is no good way available for separation of Al and copper current collectors from battery electrodes without destroying the current collectors. It is particularly difficult to remove the electrode (also called active) material from an Al collector without damaging the Al collector for avoiding possible contamination to the battery active material. Cathode materials and Al foil are tightly attached by the Polyvinylidene fluoride (PVDF) and the intact liberation of cathode materials remains difficult but essential. To detach cathode materials and Al foil, there are three common strategies including thermal treatment, lye treatment, and solvent dissolution. All those methods would likely destroy the Al collectors and cause contamination to active materials during the recycle process.

A process reported in a patent application WO2022109453A1 is the use of low-temperature plasma in an ionized gas chamber. The plasma can be used to carry out chemical reactions to remove contaminants from the cathode powder. However, the current collector metallic foil can't be separated by this process alone. The process still uses the shredding process and thus the shape and size of the current collectors are destroyed.

There is a tryout to use electrohydraulic fragmentation for lithium ion battery material recycling based on a principle of electric shockwave. This electric shockwave method needs a very high voltage 20-40 kV to generate the shock wave in a water medium. The water medium should not be added with chemicals in order to have a low electric conductivity. The shockwave can provide a high pressure to destroy the weak connecting points. The battery electrode (active) materials can be separated from the current collectors. The peeled-off electrode materials and the deformed current collectors are still mixed in the water, and they need to be sorted out separately. It should be also noticed that the high voltage used is not directly applied on the battery materials.

This invention brings out a method for direct separation of an electrode material from a spent battery through localized bubble formation and collapsing directly on the electrode surface under a voltage of less than 600 volts (V). The bubble collapsing generates a strong impacting force on the electrode (active) material surface and causes the separation of the battery material. As a result, the battery electrode material is removed from the Al or Cu current collector. The Al and Cu collectors still keep their structural shapes and dimensions as well as their chemical compositions and microstructures without being altered.

In this invention, the spent electrode is first obtained by disassembling an electrical battery manually or preferably through robot automation. The robot arm can grab the spent cathode and anode electrode one by one, and put the cathode electrode into one electrolyte tank and the anode into another electrolyte tank where a selected voltage is applied on each electrode. The electrodes are connected to a DC or DC pulse power supply, preferably to its negative terminal. Consequently, the electrode (active) material is separated from the current collector of each electrode under this claimed method. The electrode active material (Li, Co, Ni, Mn or other precise metals) from the cathode is collected into one electrolyte tank and the electrode active material (Li, Graphite, or Silicon) from the anode into another electrolyte tank. The current collectors (aluminum foil or copper foil) can be stacked up and re-used as metallic foils for making new battery electrodes. The electrode active materials peeled off from the collectors as small fragments can be recycled or re-generated for making a new battery. By doing so, circular economy can be realized.

### SUMMARY OF THE INVENTION

The invention hereby involves a separation method of battery electrode materials from a spent battery electrode for battery recycling. The battery electrode consists of an electrode material and a current collector. The separation method includes the following steps: immersing a battery electrode with an electrolyte, applying an electric current directly on the battery electrode, generating gas bubbles on the battery electrode material surface, generating electric discharging sparks inside the gas bubbles under a selected electric voltage, collapsing the gas bubbles under the selected electric voltage, destructing the interface adhesion of the battery electrode (active) material under the impacting pressure sourced from the bubble collapsing, and spallation of the electrode (active) material from the current collector foil. This method can be applied for a lithium ion battery and other batteries which contain electrode (active) materials and current collectors.

In the invention, the electrolyte used for the separation process can be a weak alkaline or acidic aqueous liquid. As an example, an electrolyte can be prepared by adding 1-15 wt. % NaHCO₃ in water. The selected voltage and current density are in a range of 100-600 volts and 0.03-3 A/cm² respectively. The power supply for generating the selected voltage and current can be a DC or pulse DC power supply. The battery electrode material to be treated is preferably connected to a negative terminal of the power supply. The gas bubbles formed on the treated battery electrode surface are water vapor and hydrogen gas bubbles, which collapse and generate an impacting pressure on the battery material surface. The battery electrode (active) material is separated under such an impacting pressure force.

In the invention, the battery electrode material to be treated is connected alternatively to a positive terminal of the power supply. The gas bubbles formed on the treated battery electrode surface are water vapor and oxygen gas bubbles, which collapse and generate an impacting pressure on the battery material surface. The battery active material is separated under such an impacting pressure force. The current collector can be re-used after the battery active material is stripped off. The battery active material can be re-generated or recycled for making a new battery electrode using calcination, pyrometallurgy and hydrometallurgy methods.

### BRIEF DESCRIPTION OF THE DRAWINGS

FIG. 1 is a schematic illustration of a separation method of a battery electrode (active) material from a spent battery electrode.

### DETAILED DESCRIPTION OF THE INVENTION

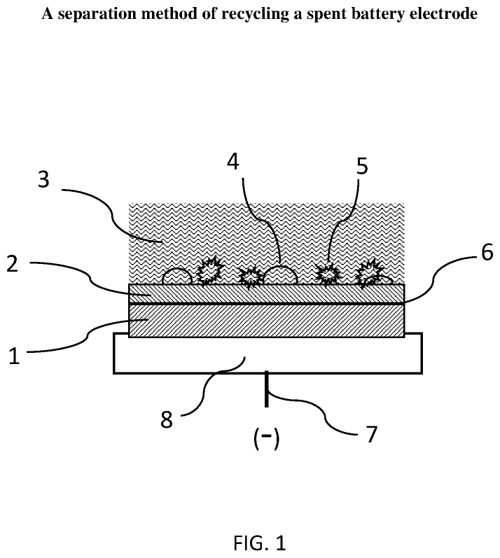

Referring to the schematic illustration in FIG. 1, a spent battery electrode has a metallic current collector 1 and an electrode (active) material layer 2 which contacts an aqueous electrolyte 3. On the surface of the electrode (active) material layer 2, gas bubbles 4 are generated and some of the bubbles lead to plasma spark discharges 5 when a selected electric voltage and a selected electric current 7 are applied. The selected voltage and current density 7 are preferably in a range of 100-600 volts (V) and 0.03-3.0 A/cm² respectively. When the plasma spark discharging occurs to a gas bubble, a micro-sized explosion and collapsing of the bubble take place on the surface of the electrode material 2. Each gas bubble explosion and collapsing (4 and 5) under the voltage and current 7 forms a high impacting pressure locally on the spent battery electrode surface, greatly weakening the interface 6 bonding strength of the battery electrode (active) materials 2 to the metallic electric current collector 1 at a local position where the gas bubble is formed, exploded and collapsed. Since the gas bubbles are covering everywhere of the surface of the electrode (active) material layer, the pressure impacting would deteriorate the interface 6, and subsequently the electrode (active) material layer 2 experiences fragments and spallation from the battery current collector 1. A liquid electrolyte 3 stirring or ultrasonic can help to clean the electrode (active) material 2 away from the metallic current collector 1. The electrode material fragments are collected in the liquid (i.e., electrolyte 3). The metallic foil (i.e., collector 1) is in a good shape after the above separation process, and it can be moved away from a fixture holder 8 and stacked outside the liquid for reuse. The electrode (active) materials 2 are filtered out from the liquid.

Referring to the schematic illustration in FIG. 1, the spent battery electrode containing a current collector 1 and an electrode (active) material 2 is connected, through a fixture holder 8, to a power supply and applied with a selected voltage and current 7. The selected voltage and current 7 are preferably in a range of 100-600 volts (v) and 0.03-3.0 A/cm² respectively. The power supply generates a DC (direct current) or pulse DC electric power. The fixture holder 8 is connected preferably to the negative terminal of the power supply. Alternatively, the fixture holder 8 can be connected to the positive terminal of the power supply.

In accordance with embodiments of this invention, the spent battery electrode containing a current collector 1 and an electrode material 2 is connected, through a fixture holder 8, to a power supply and applied with selected voltage and current 7. The selected voltage and current 7 are preferably in a range of 100-600 volts and 0.03-3.0 A/cm² respectively. The power supply generates a DC (direct current) or pulse DC electric power. The fixture holder 8 is connected preferably to the negative terminal of the power supply. On the electrode material layer 2 surface, water vapor and hydrogen gas bubbles are generated under the applied electric current. Under the applied voltage, the gas bubbles are collapsed, which generates a high impacting pressure and weakens the interfacial adhesion, leading to separation of the electrode material 2 away from the current collector 1.

In accordance with embodiments of this invention, the spent battery electrode containing a current collector 1 and an electrode material 2 is connected, through a fixture holder 8, to a power supply and applied with a selected voltage and current 7. The selected voltage and current 7 are preferably in a range of 100-600 V and 0.03-3.0 A/cm² respectively. The power supply generates a DC (direct current) or pulse DC electric power. The fixture holder 8 is connected to the positive terminal of the power supply. On the electrode material layer 2 surface, water vapor and oxygen gas bubbles are generated under the applied current. Under the applied voltage, the bubbles are collapsed, which generates a high impacting pressure and weakens the interfacial adhesion, leading to separation of the electrode material 1 away from the current collector 2.

In accordance with embodiments of this invention, a spent battery cathode electrode has an aluminium foil (i.e., current collector) and an electrode (active) material layer which will contact the liquid electrolyte in this disclosed process. The electrode active materials can be LiCoO₂ (LCO), LiNiₓMn_{y}Co_{z}O₂ (NMC), LiMn₂O₄ (LMO), LiFePO₄ (LFP), or others. On the surface of the electrode material layer, gas bubbles are generated and some of the bubbles lead to plasma discharges under 100-600 V and current 0.03-3.0 A/cm². Gas bubble exploding and collapsing under the voltage and current generate a high impacting pressure on the spent battery cathode surface, which weakens the interface of the battery electrode materials layer and the aluminum electric collector. Subsequently the electrode material layer experiences fragments and spallation from the aluminium foil. A liquid electrolyte stirring or ultrasonic can help to clean the electrode material away from the metallic current collector. The electrode material fragments are collected in the liquid electrolyte. The aluminum foil can be picked up and stacked outside the liquid. The electrode material is filtered out from the liquid.

In accordance with embodiments of this invention, a spent battery anode electrode has a copper foil (i.e., current collector) and an active material layer which contacts an electrolyte during this disclosed separation process. The electrode (active) material can be graphite, silicon or others. On the surface of the electrode material layer, gas bubbles are generated and some of the bubbles lead to plasma discharging under 100-600 V and current 0.03-3.0 A/cm². Gas bubble exploding and collapsing under the voltage and current generate a high impacting pressure on the spent battery anode surface, which weakens the interface of the battery electrode material layer and the copper foil. Subsequently the active material layer experiences fragments and spallation from the copper foil. A liquid electrolyte stirring or ultrasonic can help to clean the electrode materials away from the metallic current collector. The electrode active materials fragments are collected in the liquid electrolyte. The copper foil can be relocated and stacked outside the liquid. The electrode material is filtered out from the liquid.

In accordance with embodiments of this invention, cathode materials removed away from aluminum foils can be collected and used as the precursors which are then mixed with Li sources at an ideal molar ratio. Subsequently, the mixture is thermally treated at a low temperature (250-350° C.) and then a high temperature (600-950° C.) to prepare for regenerating the cathode materials. The aluminum foils can be directly re-used as electric current collectors. The regenerated cathode materials can be used to make new cathodes for battery electric vehicles or energy storage systems.

In accordance with embodiments of this invention, cathode materials removed away from aluminum foils can be collected and used as the precursors which are then mixed with Li sources at an ideal molar ratio. To enhance the recovery efficiency of metallic elements, a leaching process can be applied to the obtained cathode active materials first by acid solution. The precursors are produced from the acid leaching solution through the treatment. The purified precursors can function as raw materials to regenerate new cathodes via a solid-state reaction.

In accordance with embodiments of this invention, battery electrode active materials removed from aluminum or copper foils can be collected. Pyrometallurgy can be used to convert metal oxides used in battery materials to metals or metal compounds. In reductive roasting (smelting), the battery materials are heated under vacuum or inert atmosphere to convert the metal oxides to a mixed metal alloy containing (depending on the battery composition) cobalt, nickel, copper, and iron.

In accordance with embodiments of this invention, battery electrode active materials removed away from aluminum or copper foils can be collected. Hydrometallurgical methods can be used in primarily aqueous solutions to extract and separate precious metals from lithium ion battery. The pretreated battery materials are most often extracted with H₂SO₄ and H₂O₂, although HCl, HNO₃, and organic acids including citric and oxalic acids are commonly used. Once metals have been extracted into solution, they are precipitated selectively as salts using pH variation or extracted using organic solvents containing extractants such as dialkyl phosphates or phosphinates.

In accordance with embodiments of this invention, the aluminum or copper foils can be re-used to make a new battery after the electrode materials are removed from a spent battery.

The invention claimed is:

1. A method for separating an electrode material directly from a current collector foil of a spent battery electrode, the method comprising:
applying an aqueous electrolyte onto a surface of an spent electrode, the electrode having an electrode material and a current collector; applying an electric voltage and an electric current onto the spent electrode; generating a number of gas bubbles of the electrolyte directly on the surface of the spent electrode; generating a discharging spark inside each of gas bubbles due to the applied electric voltage; exploding and collapsing of the spark-discharged gas bubble directly on the surface of the spent electrode; generating an impacting pressure from each collapsed bubble onto the surface of the spent electrode; weakening the bonding strength of the interface of the electrode material and the current collector; separating the electrode material from the current collector of the spent electrode; stacking the separated current collector for direct re-use; and filtering the separated electrode material for recycling or regenerating.

2. The separation method as claimed in claim 1, wherein the electrolyte is a weak alkaline or acidic aqueous liquid.

3. The separation method as claimed in claim 1, wherein the electrolyte is preferably a weak alkaline aqueous liquid prepared by adding 1-15 wt. % NaHCO₃ in water.

4. The separation method as claimed in claim 1, wherein the electrode is a spent lithium-ion battery cathode or anode.

5. The separation method as claimed in claim 1, wherein the electric voltage is in a range of 100-600 volts (V) and the electric current density is in a range of 0.03-3.0 Ampere per square centimeter (A/cm²).

6. The separation method as claimed in claim 1, wherein the electric voltage is a DC voltage or a pulsed DC voltage.

7. The separation method as claimed in claim 1, wherein the electric voltage is preferably a negative voltage.

8. The separation method as claimed in claim 1, wherein the separated current collector is a copper foil or an aluminium foil for direct re-use as a current collector of a new battery.

9. The separation method as claimed in claim 1, wherein the separated electrode material is a material for recycling or regenerating for making a new battery.
